(19) United States
(12) Patent Application Publication
(10) Pub. No.: US 2013/0210443 A1
(43) Pub. Date: Aug. 15, 2013

(54) Mobility in Heterogeneous Network Environments

(71) Applicants: Klaus Ingemann Pedersen, Aalborg (DK); Juergen Mayer, Blaustein (DE)

(72) Inventors: Klaus Ingemann Pedersen, Aalborg (DK); Juergen Mayer, Blaustein (DE)

(73) Assignee: Nokia Siemens Networks Oy, Espoo (FI)

(21) Appl. No.: 13/821,256

(22) PCT Filed: Sep. 7, 2010
(86) PCT No.: PCT/EP2010/063098

§ 371 Date: Apr. 1, 2013

(51) Int. Cl. H04W 36/32

(52) U.S. Cl. CPC H04W 36/32
USPC 455/441

(57) ABSTRACT

There are provided measures for mobility in heterogeneous network environments, said measures exemplarily including configuring, at a network entity, and/or transmitting, from the network entity to one or more terminals, one or more terminal-unspecific handover qualification data defining a qualification of one or more cells for handover cell selection depending on a terminal speed, autonomously determining a terminal speed, and selecting one or more cells for handover cell selection using the received one or more handover qualification data on the basis of the determined terminal speed. Said measures may exemplarily be applied for mobility procedures in heterogeneous network environments based on LTE, LTE-Advanced, HSPA and/or UMTS radio access systems.

### FIELD OF THE INVENTION

The present invention relates to mobility in heterogeneous network environments.

### BACKGROUND OF THE INVENTION

In the development of radio communication systems, in particular cellular communication (like for example GSM (Global System for Mobile Communication), GPRS (General Packet Radio Service), HSPA (High Speed Packet Access), UMTS (Universal Mobile Telecommunication System) or the like), efforts are made for an evolution of the radio access part thereof. In this regard, the evolution of radio access networks (like for example the GSM EDGE radio access network (GERAN) and the Universal Terrestrial Radio Access Network (UTRAN) or the like) is currently addressed. Such improved radio access networks are sometimes denoted as evolved or advanced radio access networks (like for example the Evolved Universal Terrestrial Radio Access Network (E-UTRAN)) or as being part of a long-term evolution (LTE) or LTE-Advanced, also generally referred to as International Mobile Communications-Advanced (IMT-A). Although such denominations primarily stem from 3GPP (Third Generation Partnership Project) terminology, the usage thereof hereinafter does not limit the respective description to 3GPP technology, but generally refers to any kind of radio access evolution irrespective of the underlying system architecture.

In the following, for the sake of intelligibility, LTE (Long-Term Evolution according to 3GPP terminology) or LTE-Advanced is taken as a non-limiting example for a radio access network of cellular type being applicable in the context of the present invention and its embodiments. However, it is to be noted that any kind of radio access network of cellular type, such as GSM, GPRS, HSPA and/or UMTS, may likewise be applicable, as long as it exhibits comparable features and characteristics as described hereinafter.

In the development of cellular systems in general, and access networks in particular, heterogeneous network environments, also referred to as multi-layer cellular network systems, comprising a combination of macrocells and microcells (also referred to as picocells or femtocells) are proposed as one concept. Thereby, the macrocells (having high transmit power) typically provide for a large geographical coverage, while the microcells (having low transmit power) typically provide for additional capacity of low geographical coverage in areas with a high user deployment. In the context of LTE or LTE-Advanced, the macrocells are typically deployed by base stations denoted as eNBs, while microcells are typically deployed by home base stations denoted as HeNBs. Such heterogeneous network environment may, thus, be considered to be composed at least of two network layers, i.e. a microcell layer and an overlay macrocell layer.

The two network layers of a heterogeneous network environment, i.e. the base stations and/or cells of the two network layers, may be implemented by the same or different radio access technologies. For example, a heterogeneous network environment may be composed of a GSM-based macrocell layer and a LTE-based microcell layer.

FIG. 1 shows a schematic diagram of a deployment scenario of a heterogeneous network environment comprising a combination of macrocells and microcells. In FIG. 1, macrocells are illustrated by hexagonal blocks, while microcells are illustrated by rectangular blocks. In the dashed circle, an enlarged view of a microcell including a microcell base station and a user equipment is illustrated.

Multi-layer or heterogeneous (e.g. LTE-based) networks might be deployed using co-channel deployment, dedicate carrier deployment, or a combination of those. In co-channel deployment, both the macro and micro base stations are using the same carrier frequency. In dedicate carrier deployment, macro and micro base stations are using different carrier frequencies.

Irrespective of the deployment scenario, efficient mobility techniques are to be ensured in any multi-layer or heterogeneous (e.g. LTE-based) networks, such as in any cellular communication network. In this regard, in multi-layer or heterogeneous (e.g. LTE-based) networks, a particular aspect is to reduce or even avoid any (in particular, numerous) reselections of cells in handover cell selection. In particular, any reselection between cells of different network layers during a handover procedure is detrimental to the efficiency of mobility.

Accordingly, it is desirable to have a mechanism where, during handover procedures, terminals (also referred to as user equipments UEs) moving with high speed are kept at the macro layer (i.e. are continued to be served by macrocells or macro base stations) to avoid a larger number of cell reselections, which would otherwise be experienced in case the terminal moving with high speed travels through, and is served by many microcells (i.e. by frequently changing micro base stations). On the other hand, terminals moving with lower speed should preferably be allowed to also be served by microcells or micro base station.

In this regard, current standards, e.g. current 3GPP Rel-9 LTE specifications, include a number of control aggregates that can be used in view of the above issue.

For example, it is known to estimate the speed of the different terminals at the network side, particularly at the base station, such as an eNB/HeNB, serving these different terminals. This may be accomplished by monitoring the so-called UE history information that is communicated over the X2 interface. The so-called UE history includes information such as the previously visited cells, the time the UE stayed in the previously visited cell, and the like. Hence, the base station, such as the eNB/HeNB, can use the UE history information to obtain a rough estimate of the UE speed. This procedure can be applied for terminals in RRC_Connected state.

For example, it is known that so-called blacklists can be provided to prevent a terminal from reselections to specific intra- and inter-frequency neighboring cells. To this end, separate blacklists are known to be introduced within certain system information blocks (e.g. SIB4 and SIB5) for terminals in RRC_Idle state and within a measurement configuration for terminals in RRC_Connected state.

Thus, this basically means that it is known that the network, i.e. a base station at the network side, may estimate the speed of each terminal based on the so-called UE history information. For high speed terminals, a UE-specifically customized blacklist may be configured and provided to each terminal depending on each terminal's network-estimated speed. The thus configured and provided blacklist is capable of preventing the respective terminal from making cell reselections to microcells or micro base stations, when moving with a high speed. That is, an efficient mobility technique for multi-layer or heterogeneous (e.g. LTE-based) networks may be accomplished by virtue of a network-based approach.

However, the disadvantage of such network-based approach is that the network has to monitor the UE history information of each terminal, followed by a potential signaling of new blacklists, or whitelists, to the different terminals as their speed is changing. Accordingly, such conventional approach poses a high load and high computational efforts on the network side, particularly on a base station serving a large number of terminals, and necessitates high signaling load for signaling the individually customized UE-specific blacklists to the individual terminals, resulting in undesirable signaling overhead in the network, especially on signaling channels thereof. Further, the network-based speed estimate is rather rough and incurs some delay in mobility processing so that the resulting blacklist may be inaccurate and/or already obsolete when being received at the respective terminal.

In view thereof, there are several problems in the conventional network-based approach, which are to be overcome or at least mitigated for providing an efficient mobility technique in multi-layer or heterogeneous (e.g. LTE-based) networks.

Accordingly, there is a demand for mechanisms for mobility in heterogeneous networks, which may efficiently ensure that high speed terminals are kept at the macrocell network layer during handover procedures, while low speed terminals may be allowed to be served by both the macrocell and microcell network layers during handover procedures.

### SUMMARY OF EMBODIMENTS OF THE INVENTION

The present invention and its embodiments aim at solving the above problems.

The present invention and its embodiments are made to provide for mechanisms for mobility in heterogeneous networks, which may efficiently ensure that high speed terminals are kept at the macrocell network layer during handover procedures, while low speed terminals may be allowed to be served by both the macrocell and microcell network layers during handover procedures.

According to an exemplary first aspect of the present invention, there is provided a method comprising receiving, from a network entity, one or more terminal-unspecific cell handover qualification data defining a qualification of one or more cells for handover cell selection depending on a terminal speed, autonomously determining a terminal speed, and selecting one or more cells for handover cell selection using the received one or more cell handover qualification data on the basis of the determined terminal speed.

According to further developments or modifications thereof, one or more of the following applies:
the one or more cell handover qualification data comprises at least one of one or more candidate blacklists defining one or more black cells being unqualified for handover cell selection depending on a terminal speed, one or more candidate whitelists defining one or more white cells being qualified for handover cell selection depending on a terminal speed, and one or more cell individual offsets defining a degree of qualification of one or more cells for handover cell selection depending on a terminal speed,
the method further comprises at least one of selecting one or more black cells from received one or more candidate blacklists, and applying the selected one or more black cells for handover cell selection by omitting monitoring of selected cells among neighboring cells, selecting one or more white cells from received one or more candidate whitelists, and applying the selected one or more white cells for handover cell selection by omitting monitoring of non-selected cells among neighboring cells, and selecting one or more cells using the received one or more cell individual offsets, and applying the selected one or more cells for handover cell selection by omitting monitoring of selected cells among neighboring cells,
the selecting comprises assigning a terminal speed interval by comparing the determined terminal speed with at least one fixed or configurable threshold, and activating a cell handover qualification data or relevant one or more entries thereof being relevant for the assigned terminal speed interval,
the selecting comprises at least one of activating the one received cell handover qualification data dedicated for a certain terminal speed interval, activating one cell handover qualification data out of multiple received cell handover qualification data dedicated for different terminal speed intervals, and activating one or more entries, which are dedicated for a certain terminal speed interval, from the one received cell handover qualification data,
in a heterogeneous network environment comprising at least a macrocell layer and a microcell layer, the one or more selected cells are black cells of the microcell layer and/or white cells of the macrocell layer and/or cells of the microcell layer having an unqualifying cell individual offset, if the determined terminal speed is above a certain fixed or configurable threshold,
the method further comprises detecting a number of experienced cell reselections in RRC_Idle state and/or a number of handovers in RRC_Connected state, wherein said terminal speed is determined based on the detected number of experienced cell reselections in RRC_Idle state and/or the detected number of handovers in RRC_Connected state,
the method further comprises detecting a speed measurement using a speed measurement device, wherein said terminal speed is determined based on the detected speed measurement,
the receiving comprises receiving, at a terminal in the RRC_Idle state, the one or more cell handover qualification data being included in a system information block, and/or signaling, at a terminal in the RRC_Active state, the one or more cell handover qualification data as part of a measurement configuration,
the method is operable at said terminal, and/or
the network entity comprises a base station, eNB, and/or a home base station, HeNB, in accordance with an LTE or LTE-Advanced radio access system.

According to an exemplary second aspect of the present invention, there is provided an apparatus comprising a receiver configured to receive, from a network entity, one or more terminal-unspecific cell handover qualification data defining a qualification of one or more cells for handover cell selection depending on a terminal speed, and a processor configured to autonomously determine a terminal speed, and select one or more cells for handover cell selection using the received one or more cell handover qualification data on the basis of the determined terminal speed.

According to further developments or modifications thereof, one or more of the following applies:
the one or more cell handover qualification data comprises at least one of one or more candidate blacklists defining one or more black cells being unqualified for handover cell selection depending on a terminal speed, one or more candidate whitelists defining one or more white cells being qualified for handover cell selection depending on a terminal speed, and one or more cell individual offsets defining a degree of qualification of one or more cells for handover cell selection depending on a terminal speed,
the processor is further configured to select one or more black cells from received one or more candidate blacklists, and apply the selected one or more black cells for handover cell selection by omitting monitoring of black cells among neighboring cells, and/or select one or more white cells from received one or more candidate whitelists, and apply the selected one or more white cells for handover cell selection by omitting monitoring of non-selected cells among neighboring cells, and/or select one or more cells using the received one or more cell individual offsets, and apply the selected one or more cells for handover cell selection by omitting monitoring of selected cells among neighboring cells,
the processor, for selecting, is configured to assign a terminal speed interval by comparing the determined terminal speed with at least one fixed or configurable threshold, and activate a cell handover qualification data or relevant one or more entries thereof being relevant for the assigned terminal speed interval,
the processor, for selecting, is configured to activate the one received cell handover qualification data dedicated for a certain terminal speed interval, and/or activate one cell handover qualification data out of multiple received cell handover qualification data dedicated for different terminal speed intervals, and/or activate one or more entries, which are dedicated for a certain terminal speed interval, from the one received cell handover qualification data,
the processor is configured to, in a heterogeneous network environment comprising at least a macrocell layer and a microcell layer, select black cells of the microcell layer and/or white cells of the macrocell layer and/or cells of the microcell layer having an unqualifying cell individual offset as the one or more selected cells, if the determined terminal speed is above a certain fixed or configurable threshold,
the processor is configured to detect a number of experienced cell reselections in RRC_Idle state and/or a number of handovers in RRC_Connected state, and determine said terminal speed based on the detected number of experienced cell reselections in RRC_Idle state and/or the detected number of handovers in RRC_Connected state,
the apparatus further comprises a speed measurement device configured to detect a speed measurement, and the processor is configured to determine said terminal speed based on the detected speed measurement,
the receiver is configured to receive, when the terminal is in the RRC_Idle state, the one or more cell handover qualification data being included in a system information block, and/or receive, when the terminal is in the RRC_Active state, the one or more cell handover qualification data as part of a measurement configuration,
the apparatus is operable as or at said terminal, and/or
the network entity comprises a base station, eNB, and/or a home base station, HeNB, in accordance with an LTE or LTE-Advanced radio access system.

According to an exemplary third aspect of the present invention, there is provided a method comprising configuring one or more terminal-unspecific cell handover qualification data defining a qualification of one or more cells for handover cell selection depending on a terminal speed, and sending the configured one or more cell handover qualification data to terminals for their handover cell selection.

According to further developments or modifications thereof, one or more of the following applies:
the one or more cell handover qualification data comprises at least one of one or more candidate blacklists defining one or more black cells being unqualified for handover cell selection depending on a terminal speed, one or more candidate whitelists defining one or more white cells being qualified for handover cell selection depending on a terminal speed, and one or more cell individual offsets defining a degree of qualification of one or more cells for handover cell selection depending on a terminal speed,
the sending comprises signaling the configured one or more handover qualification data being included in a system information block to terminals in the RRC_Idle state, and/or signaling the configured one or more handover qualification data as part of a measurement configuration to terminals in the RRC_Active state,
the configured one or more handover qualification data is sent to terminals located within a single cell and/or to terminals located within a geographical area which is larger than a single cell, and/or
the method is operable at a base station, eNB, and/or a home base station, HeNB, in accordance with an LTE or LTE-Advanced radio access system.

According to an exemplary fourth aspect of the present invention, there is provided an apparatus comprising a processor configured to configure one or more terminal-unspecific handover qualification data defining a qualification of one or more cells for handover cell selection depending on a terminal speed, and a transmitter configured to send the configured one or more handover qualification data to terminals for their handover cell selection.

According to further developments or modifications thereof, one or more of the following applies:
the one or more cell handover qualification data comprises at least one of one or more candidate blacklists defining one or more black cells being unqualified for handover cell selection depending on a terminal speed, one or more candidate whitelists defining one or more white cells being qualified for handover cell selection depending on a terminal speed, and one or more cell individual offsets defining a degree of qualification of one or more cells for handover cell selection depending on a terminal speed,
the transmitter, for sending, is configured to signal the configured one or more handover qualification data being included in a system information block to terminals in the RRC_Idle state, and/or signal the configured one or more handover qualification data as part of a measurement configuration to terminals in the RRC_Active state,
the transmitter, for sending, is configured to send the configured one or more handover qualification data to terminals located within a single cell and/or to terminals located within a geographical area which is larger than a single cell, and/or
the apparatus is operable as or at a base station, eNB, and/or a home base station, HeNB, in accordance with an LTE or LTE-Advanced radio access system.

According to an exemplary fifth aspect of the present invention, there is provided a computer program product including a program comprising software code portions being arranged, when run on a processor of an apparatus (such as e.g. according to the above second aspect and/or developments or modifications thereof), to perform the method according to the above first aspect and/or developments or modifications thereof.

According to an exemplary sixth aspect of the present invention, there is provided a computer program product including a program comprising software code portions being arranged, when run on a processor of an apparatus (such as e.g. according to the above fourth aspect and/or developments or modifications thereof), to perform the method according to the above third aspect and/or developments or modifications thereof.

According to further developments or modifications thereof, the computer program product according to the fifth or sixth aspect comprises a computer-readable medium on which the software code portions are stored, and/or the program is directly loadable into a memory of the processor.

By way of exemplary embodiments of the present invention, there are provided mechanisms for mobility in heterogeneous networks, which may efficiently ensure that high speed terminals are kept at the macrocell network layer during handover procedures, while low speed terminals may be allowed to be served by both the macrocell and microcell network layers during handover procedures.

### BRIEF DESCRIPTION OF THE DRAWINGS

In the following, the present invention will be described in greater detail by way of non-limiting examples with reference to the accompanying drawings, in which

FIG. 1 shows an exemplary illustration of a deployment scenario of a heterogeneous network environment comprising a combination of macrocells and microcells,

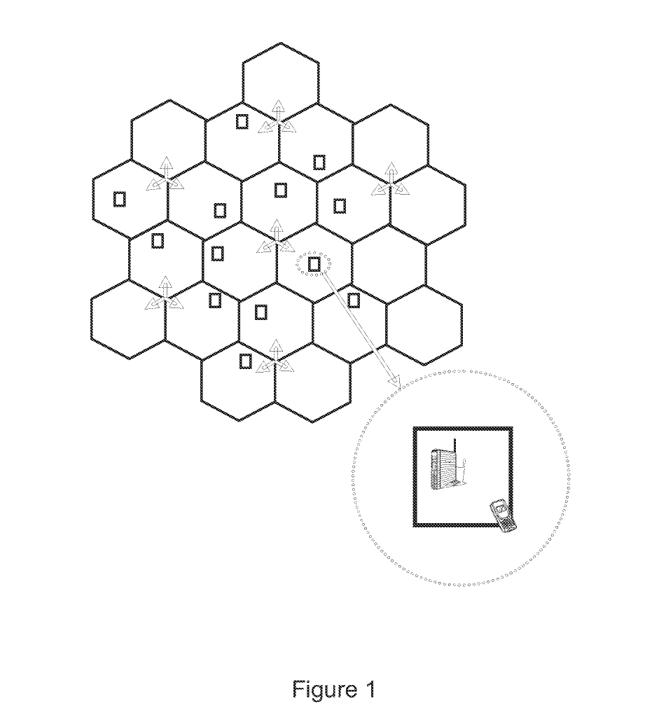

FIG. 2 shows a flowchart illustrating exemplary procedures according to exemplary embodiments of the present invention, and

FIG. 3 shows a block diagram illustrating exemplary devices according to exemplary embodiments of the present invention.

### DETAILED DESCRIPTION OF EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

Generally, the present invention and its embodiments relate to mobility in multi-layer cellular systems also referred to as heterogeneous networks. As described above, in this context, multi-layer networks refer to cases with a mixture of macro cells/base stations as well as micro cells/base stations. As an example, multi-layer LTE networks are particularly referred to herein, while the present invention and its embodiments could equally be applied to other cellular standards as well. Macro layer and micro layer may be implemented in the same or different radio access technologies RAT (for example, the macro layer could be implemented in GSM RAT and the micro layer could be implements in LTE RAT).

In particular, the present invention and its embodiments are mainly described in relation to 3GPP specifications being used as non-limiting examples for certain exemplary network configurations and deployments. In particular, an LTE/LTE-A network environment is used as a non-limiting example for the applicability of thus described exemplary embodiments. Further, a heterogeneous network environment comprising a combination of macrocells being represented by eNB nodes and microcells being represented by HeNB nodes is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment comprising multiple network layers such as e.g. macrocells and microcells, etc. may also be utilized as long as compliant with the features described herein.

Embodiments of the present invention may be equally applied to any multi-layer or heterogeneous network environments comprising a combination of macrocells and microcells, irrespective of the underlying radio access system or technology. In LTE/LTE-Advanced, embodiments of the present invention are applicable to HeNB microcells. In HSPA/UMTS, embodiments of the present invention are applicable to pico-/femtocells.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

In the following, exemplary embodiments of the present invention are described with reference to methods, procedures and functions.

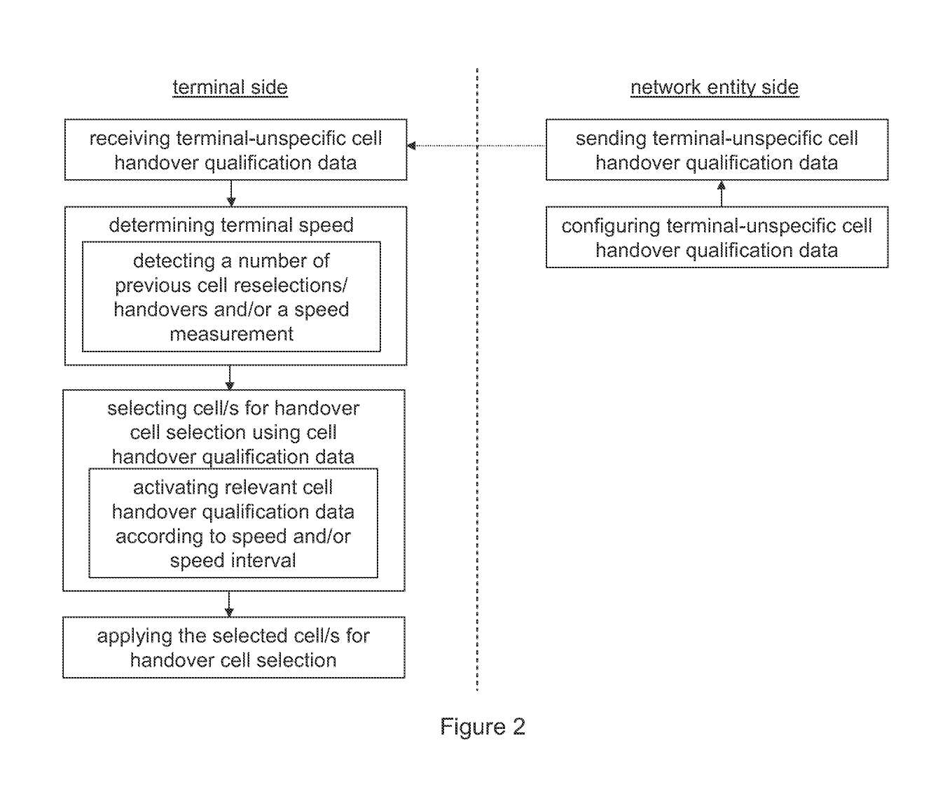

FIG. 2 shows a flowchart illustrating exemplary procedures according to exemplary embodiments of the present invention.

In FIG. 2, two mutually independent procedures are exemplarily illustrated, one at the terminal side being implemented e.g. by a user equipment UE, and one at the network side being implemented e.g. by a macro/micro layer network entity such as a eNB and/or HeNB. The present illustration of both procedures is to be understood as being exemplary only, that is not any single operation or sub-operation is necessarily to be executed in any case, as long as the result thereof may be acquired by the respective apparatus in some way.

According to exemplary embodiments, the UE representing the terminal side here is configured with one or more cell handover qualification data. In this context, cell handover qualification data comprises a definition of a qualification of one or more cells for handover cell selection depending on a terminal speed. According to exemplary embodiments, the cell handover qualification data may comprise at least one of one or more candidate blacklists defining one or more so-called black cells being unqualified for handover cell selection, one or more candidate whitelists defining one or more so-called white cells being qualified for handover cell selection, and one or more cell individual offsets defining a degree of qualification of one or more cells for handover cell selection. The cell handover qualification data according to exemplary embodiments are terminal-unspecific and may be cell-specific or not. That is, the respective cell handover qualification data are not specifically customized for a certain UE, but are applicable for a number of UEs (meaning that the cell handover qualification data, e.g. the blacklist, the whitelist, the cell individual offset) is terminal-unspecific), e.g. those residing in the same geographic area which may be a cell (in which case the cell handover qualification data is cell-specific) or even larger than a cell (in which case the cell handover qualification data is cell-unspecific). The cell handover qualification data with which the terminal is configured serve as candidate cell handover qualification/configuration data for handover cell selection, as described below.

According to exemplary embodiments, such configuration may basically comprise receipt of such terminal-unspecific, i.e. commonly applicable, cell handover qualification data from the network at the terminal, as depicted in FIG. 2.

According to exemplary embodiments, the UE representing the terminal side here determines its speed in an autonomous and/or local manner, i.e. without participation of other entities such as network entities, as depicted in FIG. 2.

According to exemplary embodiments, besides direct measuring techniques using a specific speed measurement device (such as e.g. a speedometer of a vehicle) e.g. on the basis of GPS (Global Positioning System) or the like, such terminal speed determination may be based on a number of previous cell selections and/or handovers. Optionally, the autonomous speed determination according to exemplary embodiments may be based on a number of experienced cell reselections in RRC_Idle state, which may be locally detected at the terminal. Alternatively or additionally, the autonomous speed determination according to exemplary embodiments may be based on a number of handovers in RRC_Connected state, which may be locally detected at the terminal. Stated in other words, the terminal may estimate its current speed by counting the number of cell reselections (in RRC_Idle state) and/or handovers (in RRC_Connected state), and/or the terminal may measure its current speed using a speedometer, a GPS device, or the like.

Generally, the terminal may scale several of its mobility related parameters depending on the thus determined terminal speed.

According to exemplary embodiments, the terminal may particularly select one or more cells for handover cell selection using the configured/received cell handover qualification data depending on the thus determined terminal speed in an autonomous manner. That is, in case of blacklist/s representing the cell handover qualification data, black cells may be selected, which are unqualified for handover cell selection, and/or, in case of whitelist/s representing the cell handover qualification data, white cells may be selected, which are qualified for handover cell selection, and/or in case of cell individual offset/s (CIO) representing the cell handover qualification data, cells may be selected, which are (un-)qualified for handover cell selection. In the latter case, the cell individual offset/s may be added to handover-related measurement reports (such as cell measurement quality) of respective one or more cells, and one or more cells resulting in an appropriate quality value including the CIO may be selected.

The cell handover qualification data according to exemplary embodiments are configured in relation to terminal speed. Accordingly, the cell selection on the basis of the cell handover qualification data depending on terminal speed may exemplarily be as follows.

When a single cell handover qualification data is received/configured, one or more entries thereof may be activated, which are dedicated for a certain terminal speed interval. Namely, when a single candidate blacklist/whitelist/CIO is received/configured at the terminal, certain entries thereof may be relevant for certain speeds and/or speed intervals of the terminal. Then, one or more entries thereof, which are dedicated for the currently determined terminal speed or speed interval, are activated from this candidate blacklist/whitelist/CIO. The remaining entry or entries, which are dedicated for other terminal speed or speed interval, are not activated.

When a single cell handover qualification data is received/configured, the cell handover qualification data as such may be activated. Namely, when a single blacklist/whitelist/CIO is received/configured at the terminal, the blacklist/whitelist/CIO as such may be relevant for certain speeds and/or speed intervals of the terminal. Then, this candidate blacklist/whitelist/CIO is activated when being dedicated for the currently determined terminal speed or speed interval. At another terminal speed or speed interval, for which the single blacklist/whitelist/CIO is not dedicated, handover cell selection is performed without use of this blacklist/whitelist/CIO (but, perhaps, another one). When multiple cell handover qualification data are received/configured, one cell handover qualification data thereof may be activated, which is dedicated for a certain terminal speed interval. When multiple (i.e. two or more) blacklists/whitelists/CIOs are received/configured at the terminal, one or more of this set of candidate blacklists/whitelists/CIOs may be relevant for certain speeds and/or speed intervals of the terminal. Then, one or more blacklists/whitelists/CIOs, which are dedicated for the currently determined terminal speed or speed interval, are activated from this set of candidate blacklists/whitelists/CIOs. The remaining blacklists/whitelists/CIOs, which are dedicated for other terminal speed or speed interval, are not activated.

As mentioned above, the thus selected and/or activated cells according to exemplary embodiments may be those cells with which the terminal may and will not be connected during handover, e.g. when moving fast (in case of the cell handover qualification data being blacklist/s and/or CIO/s), or those cells with which the terminal may and will be connected during handover, e.g. when moving fast (in case of the cell handover qualification data being whitelist/s and/or CIO/s according to an alternative). When no un-/qualified cells are selected and/or activated according to exemplary embodiments, the handover or handover cell selection procedure is performed without restrictions. That is, any cell out of the neighboring cell list may be selected as a handover target. Otherwise, only qualified cells are used and/or unqualified cells are prevented from being used.

According to exemplary embodiments, such cell selection or activation may be based on one or more speed thresholds defining two or more speed intervals. The one or more thresholds may be fixed and/or configurable either by the terminal or the responsible network entity. Then, the currently determined terminal speed may be compared with the one or more thresholds, thus assigning a certain terminal speed interval. The selection and/or activation may be performed when the determined terminal speed is above or below a certain threshold (and, optionally, above or below another certain threshold).

According to exemplary embodiments, specific unqualified cells may be selected, e.g. certain blacklist entries or a certain blacklist may be activated when the currently determined terminal speed is above (or below) a certain fixed or configurable threshold or within a certain fixed or configurable terminal speed interval.

For example, specific entries of a single candidate blacklist, the single candidate blacklist, or a specific one of multiple candidate blacklists may be configured to be relevant and, thus, may be activated for a terminal speed exceeding a specific threshold or for a terminal speed interval residing between two specific thresholds. In the exemplary simplest case of only one single blacklist being configured and received and one threshold T being used, the terminal activates this blacklist (i.e. its black cell entries) for handover cell selection when the currently determined terminal speed is higher than the threshold T. Similarly, the selection and/or activation may be performed in case of whitelists and/or CIOs as the cell handover qualification data, while the selection/activation result may be inverse (e.g. qualified instead of unqualified cells may be selected and handled accordingly).

According to exemplary embodiments, in a heterogeneous network environment comprising at least a macrocell layer (i.e. a network layer of macro cells or, in other terms, macro base stations of high power and high coverage area) and a microcell layer (i.e. a network layer of micro cells or, in other terms, micro base stations of low power and low coverage area) as outlined above, the one or more selected cells are black cells of the microcell layer and/or white cells of the macrocell layer and/or cells of the microcell layer having an unqualifying cell individual offset, when the currently determined terminal speed exceeds a specific threshold or when the currently assigned terminal speed interval resides between two specific thresholds. Thereby, according to exemplary embodiments, it may be ensured that high speed UEs are kept at the macro layer, while other UEs are also allowed to select the micro layer, thus avoiding a large number of reselections being performed in a handover cell selection procedure.

Hence, according to exemplary embodiments, the cell handover qualification data (e.g. backlists, whitelists, cell individual offsets) for handover cell selection are not centrally customized for individual terminals at the network side, but the usage or applicability of the respective commonly-usable cell handover qualification data is determined at the terminal side, as described below.

According to exemplary embodiments, the thus selected cells may be applied for the handover cell selection procedure to be performed by the terminal, as depicted in FIG. 2.

According to exemplary embodiments, such application for handover cell selection may comprise omission of any cell monitoring of those cells of a neighboring cell list which are the thus selected and/or activated unqualified cells, and/or execution of cell monitoring of those cells of a neighboring cell list which are the thus selected and/or activated qualified cells.

According to exemplary embodiments, the base station such as eNB/HeNB representing the network entity side here configures one or more cell handover qualification data for the handover cell selection of terminals being served by the base station, as depicted in FIG. 2. That is, as described above, these one or more cell handover qualification data serving as candidate cell handover qualification/configuration data for the served terminals are terminal-unspecific and may be cell-specific or not.

According to exemplary embodiments, the base station such as eNB/HeNB representing the network entity side here sends the thus configured cell handover qualification data to the respective terminals for configuration purposes in terms of handover call selection, as depicted in FIG. 2. That is, the thus configured terminal-unspecific cell handover qualification data may be sent to a number or all of served UEs, e.g. those residing in the same geographic area which may be a cell (in which case the cell handover qualification data is cell-specific) or even larger than a cell (in which case the cell handover qualification data is cell-unspecific.

According to exemplary embodiments, such provision of configured terminal-unspecific cell handover qualification data to respective terminals may exemplarily be as follows, while other means of providing the cell handover qualification data to respective terminals may also be envisioned.

Optionally, the cell handover qualification data may be signaled to terminals being included in a system information block (SIB), such as SIB5 and/or SIB5, which may be specifically applicable for terminals in the RRC_Idle state. Alternatively or additionally, the cell handover qualification data may be signaled to terminals as part of a measurement configuration, which may be specifically applicable for terminals in the RRC_Active state.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

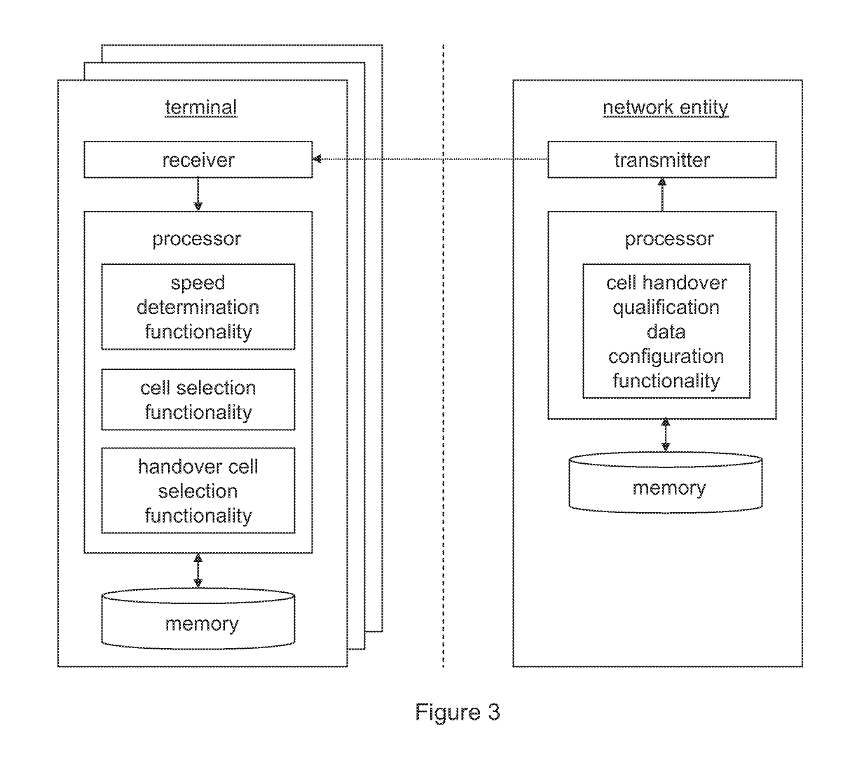

Respective exemplary embodiments of the present invention are described below referring to FIG. 3, while for the sake of brevity reference is made to the detailed description of respective corresponding methods and operations according to FIG. 2 above.

In FIG. 3 below, the solid line blocks are basically configured to perform respective operations as described above. The entirety of solid line blocks are basically configured to perform the methods and operations as described above, respectively. With respect to FIG. 3, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 3, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 3 shows a block diagram illustrating exemplary devices according to exemplary embodiments of the present invention. In view of the above, the thus described apparatus on the left side may represent a (part of a) terminal such as a user equipment UE, as described above, and the thus described apparatus on the right side may represent a (part of a) network entity such as a microcell/macrocell base station, as described above.

According to FIG. 3, the left-handed apparatus according to exemplary embodiments of the present invention is configured to perform a procedure as described in conjunction with the left side of FIG. 2, and the right-handed apparatus according to exemplary embodiments of the present invention is configured to perform a procedure as described in conjunction with the right side of FIG. 2. Therefore, while basic operations are described hereinafter, reference is made to the above description for details thereof.

According to exemplary embodiments illustrated by FIG. 3, a thus depicted apparatus related to a terminal comprises a processor and a receiver as well as, optionally, a memory.

The receiver may be specifically configured to receive, from a network entity, one or more terminal-unspecific cell handover qualification data defining a qualification of one or more cells for handover cell selection depending on a terminal speed, thus representing means for receiving terminal-unspecific cell handover qualification data for handover cell selection. The processor may be specifically configured to autonomously determine a terminal speed, thus representing means for determining a terminal speed. In other words, the processor may have a corresponding speed determination functionality (which may optionally also be realized by a speed measurement device). Further, the processor may be specifically configured to select one or more cells for handover cell selection using the received one or more cell handover qualification data on the basis of the determined terminal speed, thus representing means for selecting cell/s for handover cell selection. In other words, the processor may have a corresponding black selection functionality.

According to exemplary embodiments illustrated by FIG. 3, the processor may be specifically configured to apply the selected one or black cells for handover cell selection, e.g. by omitting or executing monitoring of unqualified or qualified cells among neighboring cells, thus representing means for applying selected cell/s for handover cell selection. In other words, the processor may have a corresponding handover cell selection functionality.

Further, the processor, or its cell selection functionality, may be specifically configured to assign a terminal speed interval by comparing the determined terminal speed with at least one fixed or configurable threshold, and to activate a cell handover qualification data or relevant one or more entries thereof being relevant for the assigned terminal speed interval. Alternatively or additionally, the processor, or its cell selection functionality, may be specifically configured to activate the one received cell handover qualification data dedicated for a certain terminal speed interval, to activate one cell handover qualification data out of multiple received cell handover qualification data dedicated for different terminal speed intervals, and/or activate one or more entries, which are dedicated for a certain terminal speed interval, from the one received cell handover qualification data. For example, in case the cell handover qualification data is represented by blacklists, the processor, or its cell selection functionality, may be specifically configured to activate a blacklist or relevant entries of a blacklist when the determined terminal speed is above a certain fixed or configurable threshold, and/or, in a heterogeneous network environment comprising a macrocell layer and a microcell layer, to select black cells of the microcell layer as the one or more selected black cells, if the determined terminal speed is above a certain fixed or configurable threshold.

In this regard, the processor, or its speed determination functionality and/or its cell selection functionality, may be specifically configured to compare a currently determined terminal speed with one or more thresholds, thus assigning a certain terminal speed interval. Namely, a cell selection or activation according to exemplary embodiments of the present invention may be based on one or more speed thresholds defining two or more speed intervals. The one or more thresholds may be fixed and/or configurable either by the terminal or the responsible network entity.

Further, the processor, or its speed determination functionality, may be specifically configured to detect a number of experienced cell reselections, e.g. in RRC_Idle state, and/or a number of handovers, e.g. in RRC_Connected state, and to determine the terminal speed based on the detected number of experienced cell reselections, e.g. in RRC_Idle state, and/or the detected number of handovers, e.g. in RRC_Connected state, and/or to detect a speed measurement using a speed measurement device, and to determine the terminal speed based on the detected speed measurement.

Further, the receiver may be specifically configured to receive, e.g. when the terminal is in the RRC_Idle state, the one or more cell handover qualification data being included in a system information block, and/or to receive, e.g. when the terminal is in the RRC_Active state, the one or more cell handover qualification data as part of a measurement configuration.

According to exemplary embodiments illustrated by FIG. 3, the thus depicted terminal may further comprise a memory. This memory may for example store any data required for and/or resulting from the above-described functionalities. For example, the memory may store the received cell handover qualification data, the threshold/s for speed interval assignment, the selected cell/s, and so forth.

According to exemplary embodiments illustrated by FIG. 3, a thus depicted apparatus related to a network entity comprises a processor and a transmitter as well as, optionally, a memory. The processor may be specifically configured to configure one or more terminal-unspecific cell handover qualification data defining a qualification of one or more cells for handover cell selection depending on a terminal speed, thus representing means for configuring terminal-unspecific cell handover qualification data for handover cell selection to be performed at a terminal side. In other words, the processor may have a corresponding candidate cell handover qualification data configuration functionality. The transmitter may be specifically configured to send the configured one or more cell handover qualification data to terminals for their handover cell selection, thus representing means for sending terminal-unspecific cell handover qualification data to terminals.

Further, the transmitter may be configured to signal the configured one or more cell handover qualification data being included in a system information block to terminals, e.g. to terminals in the RRC_Idle state, and/or to signal the configured one or more cell handover qualification data as part of a measurement configuration to terminals, e.g. to terminals in the RRC_Active state. Further, the transmitter may be configured to send the configured one or more cell handover qualification data to terminals located within a single cell and/or to terminals located within a geographical area which is larger than a single cell.

According to exemplary embodiments illustrated by FIG. 3, the thus depicted network entity may further comprise a memory. This memory may for example store any data required for and/or resulting from the above-described functionalities. For example, the memory may store configuration information for configuring cell handover qualification data, the configured cell handover qualification data, information about a RRC state of served terminals, and so forth.

According to exemplarily embodiments of the present invention, a system may comprise any conceivable combination of the thus depicted apparatuses (such as one or more terminals and associated one or more network entities such as base stations or home base stations)

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

Generally, for the purpose of the present invention as described herein above, it should be noted that
method steps and functions likely to be implemented as software code portions and being run using a processor at one of the entities, a network element, or a terminal (as examples of devices, apparatuses and/or modules thereof, or as examples of entities including apparatuses and/or modules therefor), are software code independent and can be specified using any known or future developed programming language, such as e.g. Java, C++, C, and Assembler, as long as the functionality defined by the method steps is preserved;
generally, any method step is suitable to be implemented as software or by hardware without changing the idea of the invention in terms of the functionality implemented;
method steps, functions, and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for mobility in heterogeneous network environments, said measures exemplarily comprising configuring, at a network entity, and/or transmitting, from the network entity to one or more terminals, one or more terminal-unspecific cell handover qualification data defining a qualification of one or more cells for handover cell selection depending on a terminal speed, autonomously determining a terminal speed, and selecting one or more cells for handover cell selection using the received one or more cell handover qualification data on the basis of the determined terminal speed. Said measures may exemplarily be applied for mobility procedures in heterogeneous network environments based on LTE, LTE-Advanced, HSPA and/or UMTS radio access systems.

The present invention and/or exemplary embodiments thereof are specifically effective in that, once the (terminal-unspecific) cell handover qualification data are configured to the terminal, the terminals may autonomously select between using those cell handover qualification data without any additional actions needed by the network, and the terminal may, thus, utilize the proper cells on the basis of its locally and autonomously determined speed. Hence, the network does not have to constantly monitor UE history information from each user to estimate its speed or the like, and no additional signaling is required. Namely, instead of the need of a (real-time, on-demand) provision of specifically customized candidate blacklists or the like to each terminal individually when a handover of this very terminal is to be performed, all terminals may be provided with terminal-unspecific cell handover qualification data such as candidate blacklists once and in advance (i.e. irrespective of an actual need for a handover and irrespective of a current terminal speed), and the terminal may locally decide on the application of the cell handover qualification data such as the candidate blacklists on its own. That is, according to the present invention and/or exemplary embodiments, it is the terminal that selects the currently relevant cell handover qualification data such as the blacklist and/or black cells, thus grouping terminals to macro and/or micro cells/base stations based on their traveling speed.

Accordingly, the present invention and/or exemplary embodiments are attractive from a network implementation point of view, e.g. as compared with current specifications such as e.g. current 3GPP LTE Rel-9 standards. This is because the present invention and/or exemplary embodiments put no or very little (i.e. much less) computational and traffic-related efforts to the network side.

As compared with conventional solutions, the present invention and/or exemplary embodiments may advantageously provide for less handover needs, less potentially failed handovers (i.e. less reselections, in particular of cells belonging to different network layers of a multi-layer network environment), less signaling (i.e. less network traffic), improved quality of user experience (QoE), an efficient use of macro and/or micro cells/base stations, and the like.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

1. A method comprising
receiving, from a network entity, one or more terminal-unspecific cell handover qualification data defining a qualification of one or more cells for handover cell selection depending on a terminal speed,
autonomously determining a terminal speed, and
selecting one or more cells for handover cell selection using the received one or more cell handover qualification data on the basis of the determined terminal speed.

2. The method according to claim 1, wherein the one or more cell handover qualification data comprises at least one of one or more candidate blacklists defining
one or more black cells being unqualified for handover cell selection depending on a terminal speed,
one or more candidate whitelists defining one or more white cells being qualified for handover cell selection depending on a terminal speed, and
one or more cell individual offsets defining a degree of qualification of one or more cells for handover cell selection depending on a terminal speed.

3. The method according to claim 2, further comprising at least one of
selecting one or more black cells from received one or more candidate blacklists, and applying the selected one or more black cells for handover cell selection by omitting monitoring of selected cells among neighboring cells,
selecting one or more white cells from received one or more candidate whitelists, and applying the selected one or more white cells for handover cell selection by omitting monitoring of non-selected cells among neighboring cells, and
selecting one or more cells using the received one or more cell individual offsets, and applying the selected one or more cells for handover cell selection by omitting monitoring of selected cells among neighboring cells.

4. The method according to claim 1, said selecting comprising
assigning a terminal speed interval by comparing the determined terminal speed with at least one fixed or configurable threshold, and
activating a cell handover qualification data or relevant one or more entries thereof being relevant for the assigned terminal speed interval.

5. The method according to claim 1, said selecting comprising at least one of
activating the one received cell handover qualification data dedicated for a certain terminal speed interval,
activating one cell handover qualification data out of multiple received cell handover qualification data dedicated for different terminal speed intervals, and
activating one or more entries, which are dedicated for a certain terminal speed interval, from the one received cell handover qualification data.

6. (canceled)

7. The method according to claim 1, further comprising
detecting a number of experienced cell reselections in RRC_Idle state and/or a number of handovers in RRC_Connected state, wherein said terminal speed is determined based on the detected number of experienced cell reselections in RRC_Idle state and/or the detected number of handovers in RRC_Connected state, and/or
detecting a speed measurement using a speed measurement device, wherein said terminal speed is determined based on the detected speed measurement.

8. (canceled)

9. (canceled)

10. An apparatus comprising
a receiver configured to receive, from a network entity, one or more terminal-unspecific cell handover qualification data defining a qualification of one or more cells for handover cell selection depending on a terminal speed, and
a processor configured to
autonomously determine a terminal speed, and
select one or more cells for handover cell selection using the received one or more cell handover qualification data on the basis of the determined terminal speed.

11. The apparatus according to claim 10, wherein the one or more cell handover qualification data comprises at least one of
one or more candidate blacklists defining one or more black cells being unqualified for handover cell selection depending on a terminal speed,
one or more candidate whitelists defining one or more white cells being qualified for handover cell selection depending on a terminal speed, and
one or more cell individual offsets defining a degree of qualification of one or more cells for handover cell selection depending on a terminal speed.

12. The apparatus according to claim 11, wherein the processor is further configured to
select one or more black cells from received one or more candidate blacklists, and apply the selected one or more black cells for handover cell selection by omitting monitoring of black cells among neighboring cells, and/or
select one or more white cells from received one or more candidate whitelists, and apply the selected one or more white cells for handover cell selection by omitting monitoring of non-selected cells among neighboring cells, and/or
select one or more cells using the received one or more cell individual offsets, and apply the selected one or more cells for handover cell selection by omitting monitoring of selected cells among neighboring cells.

13. The apparatus according to claim 10, wherein the processor, for selecting, is configured to
assign a terminal speed interval by comparing the determined terminal speed with at least one fixed or configurable threshold, and
activate a cell handover qualification data or relevant one or more entries thereof being relevant for the assigned terminal speed interval.

14. The apparatus according to claim 10, wherein the processor, for selecting, is configured to
activate the one received cell handover qualification data dedicated for a certain terminal speed interval, and/or
activate one cell handover qualification data out of multiple received cell handover qualification data dedicated for different terminal speed intervals, and/or
activate one or more entries, which are dedicated for a certain terminal speed interval, from the one received cell handover qualification data.

15. (canceled)

16. The apparatus according to claim 10, wherein
the processor is configured to detect a number of experienced cell reselections in RRC_Idle state and/or a number of handovers in RRC_Connected state, and determine said terminal speed based on the detected number of experienced cell reselections in RRC_Idle state and/or the detected number of handovers in RRC_Connected state, and/or
the apparatus further comprises a speed measurement device configured to detect a speed measurement, and the processor is configured to determine said terminal speed based on the detected speed measurement.

17. (canceled)

18. (canceled)

19. A method comprising
configuring one or more terminal-unspecific cell handover qualification data defining a qualification of one or more cells for handover cell selection depending on a terminal speed, and
sending the configured one or more cell handover qualification data to terminals for their handover cell selection.

20. The method according to claim 19, wherein the one or more cell handover qualification data comprises at least one of
one or more candidate blacklists defining one or more black cells being unqualified for handover cell selection depending on a terminal speed,
one or more candidate whitelists defining one or more white cells being qualified for handover cell selection depending on a terminal speed, and
one or more cell individual offsets defining a degree of qualification of one or more cells for handover cell selection depending on a terminal speed.

21. The method according to claim 19, said sending comprising
signaling the configured one or more handover qualification data being included in a system information block to terminals in the RRC_Idle state, and/or
signaling the configured one or more handover qualification data as part of a measurement configuration to terminals in the RRC_Active state,
wherein the configured one or more handover qualification data is sent to terminals located within a single cell and/or to terminals located within a geographical area which is larger than a single cell.

22. (canceled)

23. An apparatus comprising
a processor configured to configure one or more terminal-unspecific handover qualification data defining a qualification of one or more cells for handover cell selection depending on a terminal speed, and
a transmitter configured to send the configured one or more handover qualification data to terminals for their hand-over cell selection.

24. The apparatus according to claim 23, wherein the one or more cell handover qualification data comprises at least one of
one or more candidate blacklists defining one or more black cells being unqualified for handover cell selection depending on a terminal speed,
one or more candidate whitelists defining one or more white cells being qualified for handover cell selection depending on a terminal speed, and
one or more cell individual offsets defining a degree of qualification of one or more cells for handover cell selection depending on a terminal speed.

25. The apparatus according to claim 23, wherein the transmitter, for sending, is configured to
signal the configured one or more handover qualification data being included in a system information block to terminals in the RRC_Idle state, and/or
signal the configured one or more handover qualification data as part of a measurement configuration to terminals in the RRC_Active state, wherein the transmitter, for sending, is configured to send the configured one or more handover qualification data to terminals located within a single cell and/or to terminals located within a geographical area which is larger than a single cell.

26. (canceled)

27. A computer program product including a program comprising software code portions being arranged, when run on a processor of an apparatus, to perform the method according to claim 1.

28. A computer program product including a program comprising software code portions being arranged, when run on a processor of an apparatus, to perform the method according to claim 19.

29. (canceled)
